(19) United States
(12) Patent Application Publication
(10) Pub. No.: US 2003/0024247 A1
(43) Pub. Date: Feb. 6, 2003

(54) Ocean motion power

(76) Inventor: Kurt Henke, Folsom, CA (US)

Correspondence Address: Kurt Henke, 1127 Reston Drive, Folsom, CA, 95630, US

(21) Appl. No.: 09/917,582

(22) Filed: Jul. 30, 2001

(51) Int. Cl. F03G 6/00; F03G 7/00; B60L 8/00; B60K 16/00

(52) U.S. Cl. 60/641.8; 60/641.15

(57) ABSTRACT

To harvest energy from the oscillating ocean caused by the sun, the moon and the waves which are caused by the wind, a floating platform or optional a plurality of floating platforms anchored off shore and are connected to each other by two booms, and a hinged control deck between the platforms to keep them aligned. Each platform is surrounded by 76 floating weights and 52 more weights are inside the open court yard. Each floating weight weighs 25 tons. Each weight is connected to an opposing ram system. The weights are now moving up and down with the oscillating ocean. The downward motion is the power stroke. Each weight with only one inch per second power stroke will produce 6518 watt (theoretical value). Each platform will have a utility deck and there is a control deck between the platforms. Each deck provides room for installation of the most up to date solar and wind power equipment to harvest energy.

### BRIEF SUMMARY OF MY INVENTION

The ocean motion power concept is to increase and maximize the removal of energy from the oscillating ocean or any other body of water with an oscillating surface over prior art.

### BACKGROUND OF MY INVENTION

The present invention is novel and relates generally to wave pumps. More particularly, it relates to an improvement over prior art devices, pertaining to the construction of such devices designed to increase and maximize the removal of energy from the oscillating ocean over prior art. As shown in references in US CL 417/53 Field of search 417-131 U.S. Pat. No. 4,105,368 inventor Fred L. Waters, dated Aug. 8, 1978 and the following patents:

| Inventor: | U.S. Pat. No.: | Issued: |
|---|---|---|
| P. J. Hagen | 738,996 | Sept. 15, 1903 |
| B. F. Jackson | 1,250,315 | Dec. 18, 1917 |
| F. Smith | 1,647,025 | Oct. 25, 1927 |
| J. Jouy | 1,818,066 | Aug. 11, 1931 |
| P. J. Young | 1,962,047 | Apr. 17, 1933 |
| J. P. Arner | 1,953,285 | Apr. 3, 1934 |
| E. Baumgartner | 3,194,008 | Jul. 13, 1965 |
| B. Kriegel | 3,487,228 | Dec. 30, 1969 |
| Brown | 4,111,610 | Sept. 5, 1979 |
| Kao et al. | 5,710,464 | Jan. 20, 1998 |
| Berg | 6,045,339 | Apr. 4, 2000 |

all utilized the upward force of the wave using floats. In my invention I use a large floating platform or a plurality of platforms surrounded by extending weights of 25 tons each around the platform and inside the open court yard to provide a system suitable for commercial energy production. The weights are held in place by static pressure at a predetermined water line and now moving up and down with the oscillating surface provided by the waves. Because the weights are close to the platform, operation under extreme weather condition is possible. The rocking of the platforms will enhance the movement of the weights. All hydraulic fluid lines and functions are inside the platforms for a safe environment. There is a control deck between the platforms and a utility deck above the platforms to provide space for installation of the most up to date solar and wind power equipment.

### BRIEF DESCRIPTION OF THE DRAWINGS

FIG. 1 Top View

FIG. 2 Typical Plan View

FIG. 3 Typical Cross Section

FIG. 4 Connected Platforms

### DETAILED DESCRIPTION OF MY INVENTION

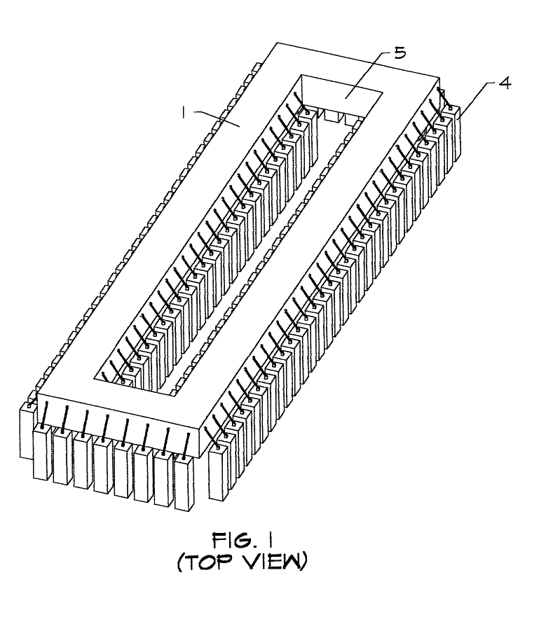

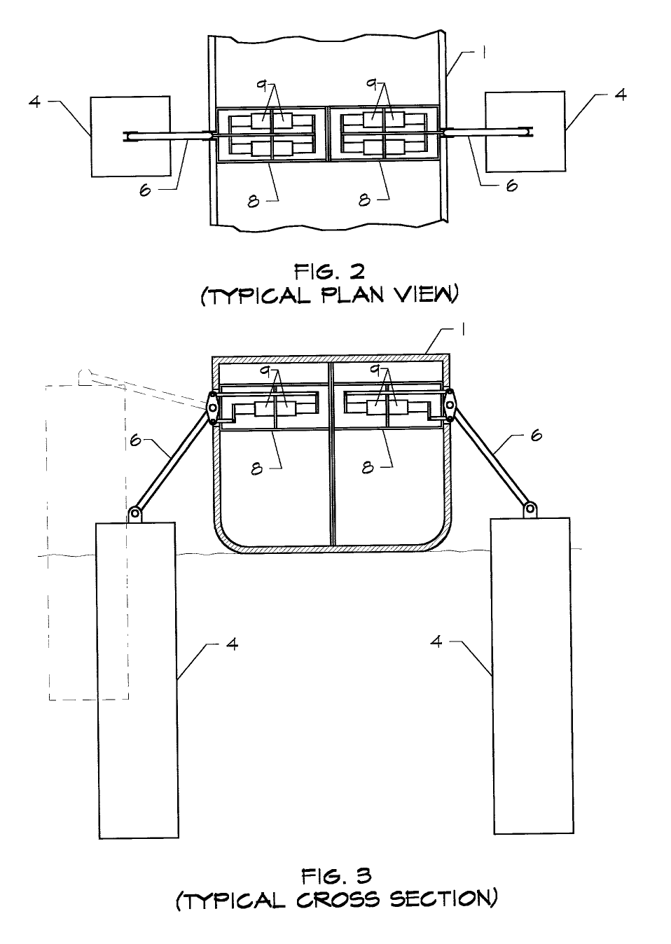

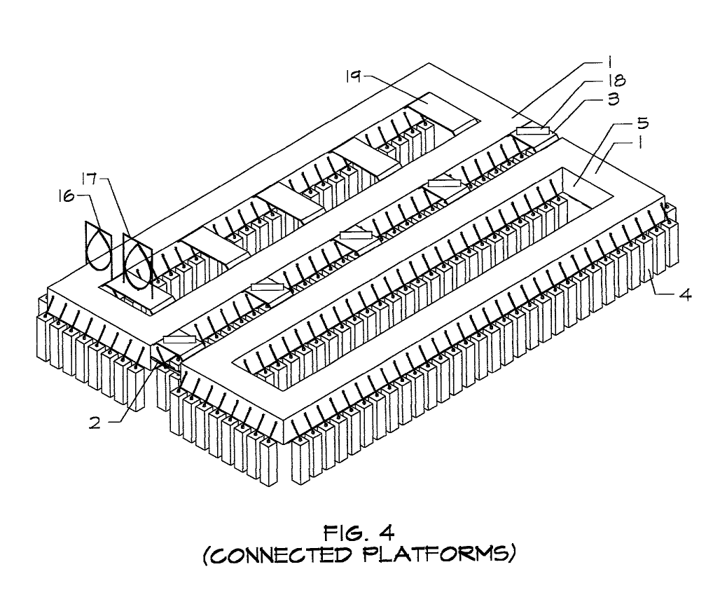

To harvest energy from the oscillating surface of the ocean a floating platform (1) FIG. 1, 270 feet long and 72 feet wide with a hull 18 by 18 feet and an open court yard (5) FIG. 1, 234 by 36 feet or a plurality of platforms anchored off shore FIG. 4 and are connected to each other by two booms (2) FIG. 4 and a control deck (3) FIG. 4 between them to keep them aligned. Each platform (1) FIG. 1 is surrounded by 76 weights (4) FIG. 3 and 52 more weights are extending from inside the open court yard (5) FIG. 1. Each floating weight (4) FIG. 3 weighs 25 tons (or as chosen) in the size of 6 by 6 feet by 24 feet is a container filled with gravel or any other suitable material of 25 tons minus the weight of the container and the weight of the beam (6) FIG. 3. Now the weight (4) FIG. 3 with the given configuration is held in place by static pressure at a predetermined water line. 2.4 feet of the weight is above the surface and it will rise and fall with the oscillating ocean. Each weight (4) FIG. 3 is connected to a beam (6) FIG. 3 which will rise to the platform (1) FIG. 3, is 10 feet long and is connected to the Boxer Ram System (8) FIG. 3. The downward power stroke will move the rams (9) FIG. 3 toward each other. Each Ram has a diameter of 12 inches. The Boxer Ram System (8) FIG. 3 will allow for maximum absorption of force provided by the weight (4) FIG. 3. The rams (9) FIG. 3 will produce high pressure fluid (approx. 1100 PSI.) (All items numbered 10 through 15 are explained but not shown in the drawings because they are basic off the shelf items.) Each ram (9) FIG. 3 has a high pressure fluid line (10) leading to the rotary fluid drive and a return line (11) from the rotary fluid drive (14) to the fluid reservoir (12) and from the reservoir (12) to the ram (9) FIG. 3. The high pressure line (10) has a check valve (13) opening at 1 and ½ PSI and is holding back up to 1200 PSI. The same check valve (13) is in the return line (11) but with functions in reverse. The high pressure fluid will drive a rotary fluid drive (14) which in turn will drive a generator (15) to produce electric current to be sent via a transmitting line to an on shore utility grid.

There is a hinged control deck (3) FIG. 4 between the platforms (1) FIG. 4 to keep them aligned and a utility deck (19) FIG. 4 above the platform (1) FIG. 4. Both decks provide space to install the most up to date wind power equipment, Darrieus type vertical axis wind turbine, a unit which performs independently regardless of wind direction. Must be able to tolerate motion and there is a height limit. Around the top of the platform (1) FIG. 4, 34 wind turbines (16) FIG. 4 could be installed in the size of 18 by 18 feet and 20 feet high and 13 more wind turbines (17) FIG. 4 on the utility deck (19) FIG. 4 in the size of 18 by 18 feet and 30 feet high. Solar panels (18) FIG. 4 may be installed on the hinged control deck (3) FIG. 4 as long as they do not serve as a primary wind breaker.

What I claim my invention is:

1. A hydraulic power source harnessing energy from an oscillating ocean or any other body of water with an oscillating surface.
a. A platform or a plurality of platforms with an open court yard surrounded by weights around the platform and inside the open court yard.
b. A weight of 25 tons (or chosen weight). A filled container placed in the ocean and is held by static pressure with the given configuration at a predetermined water line and now will go up and down with the oscillating surface provided by the waves.
c. A hinged control deck between the platforms to keep them aligned and a utility deck above the platforms to provide space for off shore installation of solar and wind powered equipment.

2. The apparatus of claim 1 including the “Boxer Ram” an opposing rams system for maximum absorption of force provided from the weights power stroke.
